(19) United States
(12) Patent Application Publication
(10) Pub. No.: US 2014/0035483 A1
(43) Pub. Date: Feb. 6, 2014

(54) TWO ENDED FAUX CANDLE

(71) Applicant: LightScapes Universal LLC, Westport, CA (US)

(72) Inventors: Ralph Becker, Santa Rosa, CA (US); Andrew N. Dyakon, Westport, CA (US)

(73) Assignee: LightScapes Universal LLC, Westport, CA (US)

(21) Appl. No.: 13/959,669

(22) Filed: Aug. 5, 2013

Related U.S. Application Data
(60) Provisional application No. 61/679,989, filed on Aug. 6, 2012.

(51) Int. Cl. H05B 37/02; H05B 33/08

(52) U.S. Cl. CPC F21L 15/02; H05B 33/0845
USPC 315/294; 362/184

(57) ABSTRACT

A faux candle having dual light sources including a housing extending longitudinally and having a top end and a bottom end, which creates the appearance of a candle, having an interior space extending longitudinally throughout the housing, a first light source in the interior space of the housing located at the top end of the housing and projecting upward from the interior space to provide a candle flame simulation, a second light source in the interior space of the housing located at the bottom end of the housing for projecting light downward from the end of the housing, and a power source means located in the interior space for powering the light sources.

### BACKGROUND OF THE INVENTION

The present invention is directed to a faux or fake candle using LED illumination and has an LED element on each end of the candle.

An LED candle is a light-emitting apparatus that resembles a candle, but includes an LED as the light source in lieu of a wick and a flammable fuel. One type of known LED candle includes an LED that is formed integral with a housing that resembles a candle. This type of LED candle is used solely as an LED candle. Another type of LED candle is a system that includes a housing resembling a candle, a small candle (e.g., a tealight candle) and a small LED candle (e.g., an LED candle resembling a tealight candle). Each of the candle and the LED candle can be inserted into the housing and used as the light source, but only one can be placed in the housing at one time. Accordingly, if the LED candle is in the housing and a user wants to switch to the candle, the user has to remove the LED candle from the housing and then insert the candle. Likewise, if the user wants to switch back to the LED candle, the user must remove the candle and then reinsert the LED candle.

In addition to light-emitting apparatuses that resemble candles (i.e., LED candles); there are also light-emitting apparatuses that resemble lanterns or other light-emitting devices that traditionally include a candle to produce light. Instead of candle, however, these light-emitting devices include an LED to produce light. As with any candle arrangement, a user can replace an LED candle in the light-emitting apparatus with a candle, and vice versa.

Numerous manufacturers have attempted to meet a demand for a flameless, candle-like luminary using electrical illumination. There are many imitation candles available that use incandescent lamps or LEDs as a light source. These devices address people's concern with having an open flame indoors. Most of these devices try to implement the appearance of a realistic flame using a specially shaped bulb or lens that is exposed to view. Typically, the bulb or lens sits on top of a thin cylindrical sleeve, which is shaped and colored to resemble a candle. The results are typically disappointing, especially when these devices are not illuminated. The visible, flame shaped artificial light source makes the imitation candles as a whole appear artificial. The result can look more like a caricature of a candle than a real candle. The color of incandescent light can leave something to be desired in many candles as well.

U.S. Pat. No. 6,616,308 teaches an imitation candle configured to diminish any expectation on the part of an observer of seeing an open flame. Visually, the key visual element of a real flame is a rather intense spot of light, which when viewed directly, could be bright enough in a dark environment to be a source of glare. In a dark environment, for example, when the human eye is adjusted for scotopic vision, the eye cannot tolerate the large contrasts in brightness and as a result the physical outline of the flame is often lost to the eye. In the case of artificial flame structures, often the outer surface is frosted, or the body has some pigmentation so that the flame structure is itself lit up. By spreading the light from the internal light source across a larger surface area, the intensity of light at the surface is much less than the driving source. Because of this lack of point source intensity, the brain does not interpret the flame structure as a real flame. Incandescent lamps that have clear glass flame structures reveal an intense filament, but the filaments are linear, so these only appear as point sources when viewed from some distance.

One approach to creating a realistic illusion of a flame is disclosed in U.S. patent application Ser. No. 10/844,075, filed 12 May 2004. This application discloses an LED hidden within a fixture above an imitation candle body. Light emitted by the LED is directed to illuminate the candle body and wick from above. The LED is driven by a variable current to produce flickering light. The imitation wick has a reflective tip which reflects the incident light to create a small bright spot. The bright spot at the tip of the wick is sufficiently bright that even though the light source may be flickering, the intensity remains strong enough that the eye cannot see the change in intensity of the spot. At the same time, light shines past the wick and onto the candle body where it is diffused throughout a relatively large volume. The light intensities within the candle body are much lower resulting in a dramatic, flickering effect.

### SUMMARY OF THE INVENTION

The present invention relates to a faux candle having dual light sources including a housing extending longitudinally and having a top end and a bottom end, which creates the appearance of a candle, having an interior space extending longitudinally throughout the housing, a first light source in the interior space of the housing located at the top end of the housing and projecting upward from the interior space to provide a candle flame simulation, a second light source in the interior space of the housing located at the bottom end of the housing for projecting light downward from the end of the housing, and a power source means located in the interior space for powering the light sources.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective view, partially exploded, of a candle in accordance with the present invention;

FIG. 2 is a perspective view of a candle on a stand in accordance with the present invention;

FIG. 3 is top perspective view of the candle shown in FIG. 2;

FIG. 4 is a bottom view of the candle shown in FIG. 2;

FIG. 5 is a perspective view of the power unit and top candle flame LED in accordance with the present invention;

FIG. 6 is a bottom view of the power unit shown in FIG. 5;

FIG. 7 is a top view of the power unit shown in FIG. 5;

FIG. 8 is a side view of the power unit and candle flame LED shown in FIG. 5;

FIG. 9 is another side view of the power unit and candle flame LED shown in FIG. 5; and

FIG. 10 is crosses sectional view of the power unit and candle shown in FIGS. 2 and 8.

### DETAILED DESCRIPTION OF THE INVENTION

The present invention is to a faux candle having dual LED light systems, which includes a housing extending longitudinally and having a top end and a bottom end to create the appearance of a candle, the housing having an interior space extending longitudinally and encloses a power source which is connected to LED lights which illuminate the candle. The power source is connected to a first light system, which forms the first light source and is in the form of a light-emitting diode (LED) having a flame shaped cover and located at the top of the housing, preferably in a recessed space, and projecting upward from the interior space to provide a candle flame simulation, and a second light system, which forms the second light source, preferably in the form of a pair of light-emitting diodes in a recessed space at the bottom end of the housing, for projecting light downward from the end of the housing. The power source includes and provides the means for powering the light-emitting diodes. The second light source or system will be described in terms of two lights, which is preferred, but is not intended to be limited to two lights and could be a single light or could be more than two, such as three, four, five, and the like.

Because the present invention has two LED light systems in the candle body, the lower LED lights can be used to illuminate an object when the candle is placed upon a stand having an opening which allows the light to play on an object or on a stand or pedestal which is capable of being illuminated or which is translucent or transparent.

The housing is, preferably, a plastic body, which may or may not be covered in wax, to simulate a real candle, but other materials can be so employed to form the body, such as treated paper, wood, metal, and the like. The housing has a top end and a bottom end. It can be various shapes, such as round, square, oval, etc. It can be various sizes. It can be any color wax, with and without designs, on or embedded on, or in, the wax. The wax may or may not be scented. The candle may be decorated with glitter or the like decorations. The candle housing body will preferably be a unitary body with access at one end of the body for the power source. Thus, the power source, which has the working part of the candle, i.e., the LEDs, the batteries, the controls, the switches, and the like, can be inserted into the candle housing body and joined to the candle housing body to complete the candle. The power source can be joined to the candle housing body via a wax or plastic seal, or the power source and the candle housing may be joined via a screw mechanism, force fit, a latching mechanism, or otherwise designed to allow the inner power source and housing to slide out for replacing the unit or the batteries, and re-inserted to form the candle.

The first light source or system is a light-emitting diode or LED light located at the top of the body. It can be in the hollow (or recess or depression) of the shell walls, or on top of a flat wax surface, or can be inside of a plastic, silicone, glass, or the like, material shaped flame cover. The plastic or glass shaped flame cover is not critical and can be such as is known in the art. By covering the LED light, it will give the appearance of a candle flame, but it could be other shapes. Also, there may be one or more lights. The light may be a solid light, flickering light, colored light, morphing (color changing) light, etc. LED light sources are known and there is no criticality in the light source. Known LEDs include U.S. Pat. Nos. 6,616,308 and 7,125,142 and PCT Publication WO 2009/116095, the teaching of which are incorporated herein by reference.

A second light source or system is, preferably, two LED lights located at the bottom of the body, although the number is not critical and could be a single LED light or could be more than two lights. It can be flush to the flat base, placed within a recess or depression at the bottom base, or could protrude out. The LED light can be inside of a plastic or glass shaped flame cover. There may be one or more lights. The light may be a solid light, flickering light, colored light, morphing (color changing) light, etc. The light may be enclosed in a reflector to concentrate or converge the light or a lens to disperse the light. In a preferred form of the invention, the bottom light system consisted of two LED lights, for example, one a warm yellow light and the other a white or multicolor changing light. These can be varied or selected depending upon the mood of the user or the lighting effect desired.

The power source for the LED lights is, preferably, a battery power source, located in the inside of the inner plastic housing. The type of battery may be any conventional battery necessary to operate the unit. The size of the housing and the wiring engineering will be appropriate for the lights since this is not a critical feature. Further, switch(es) are provided for operating the lights. The lights may be operated off a single power source or may work independently or together. The lights may also be operated using a timer feature for one or both of the light systems, or for all of the lights. In addition, other controls could be included to control the lighting, including but not limited to, one or more motion sensors, light sensors, touch/vibration sensors (i.e. touching the device to turn it on or off), and/or remote controls.

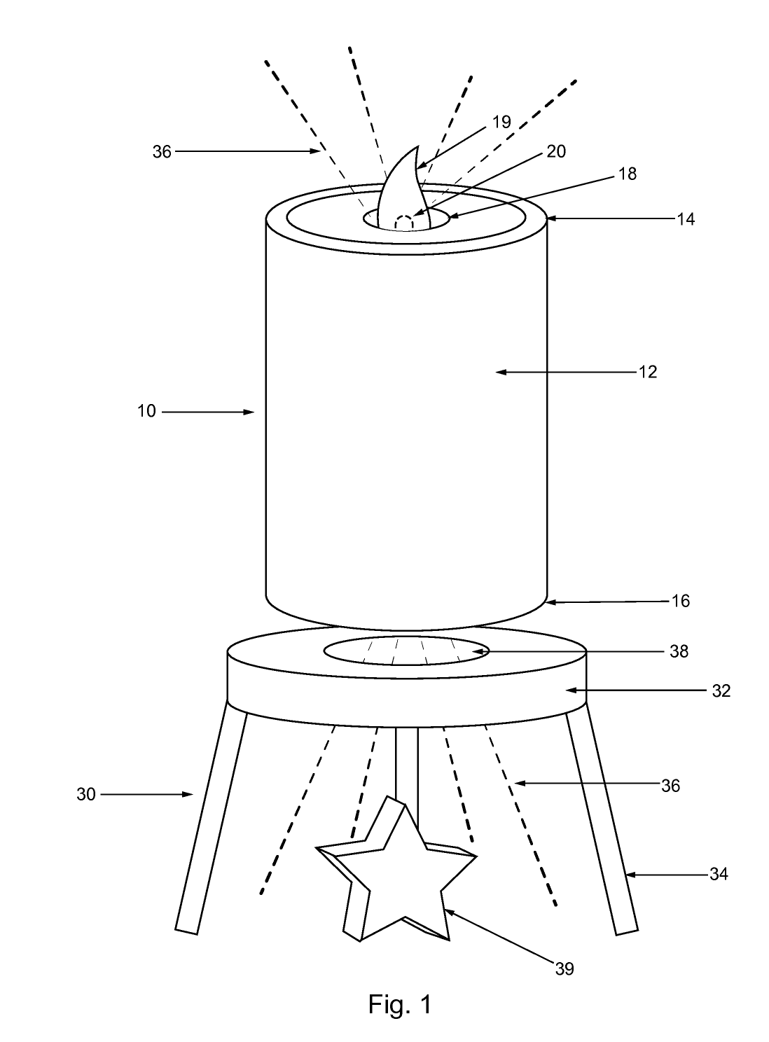

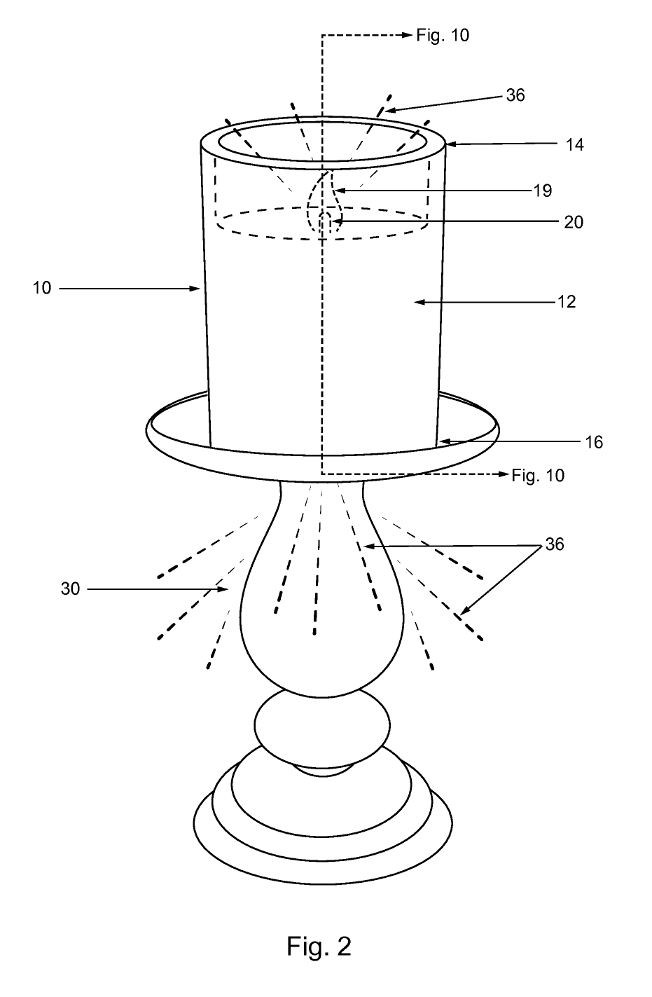

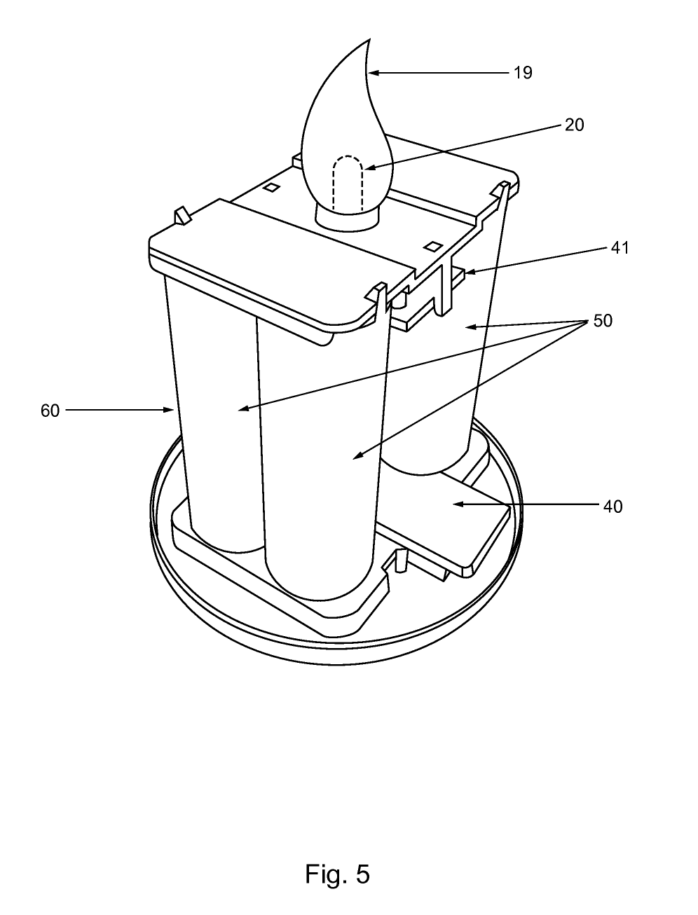

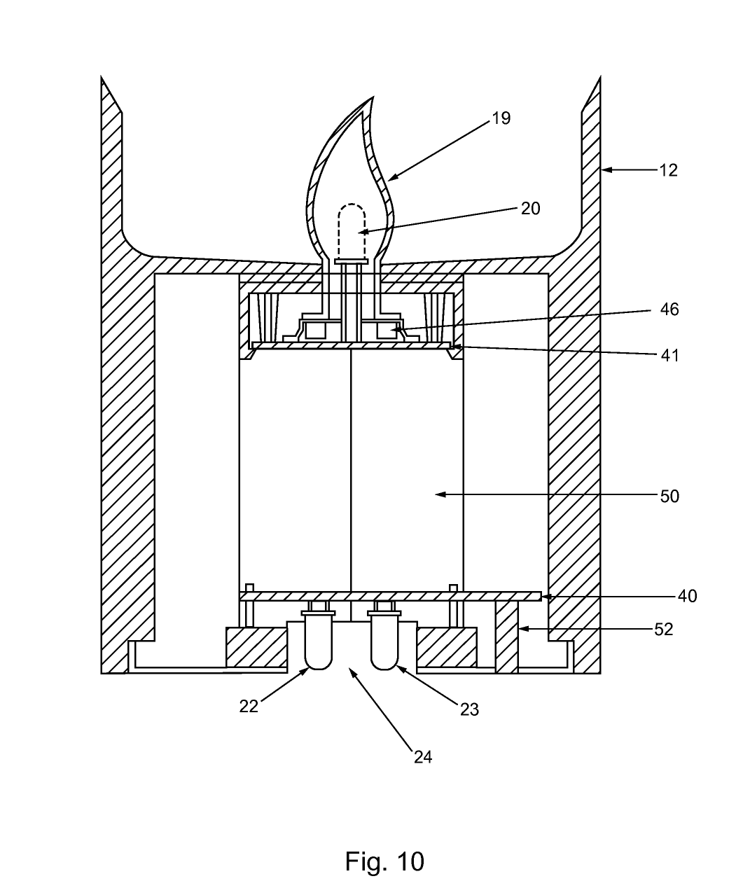

As seen in FIGS. 1 and 2, the candle 10 is made up of a candle body 12 has a top 14 and bottom 16. An opening 18 at the top enables the placement of an LED light 20 having a flame shaped cover 19, which when illuminated will give the candle the appearance of a real candle as seen from the emitted light beam 36. A second LED light system, including LEDs 22 and 23 (see FIGS. 4, 10), is placed at the bottom of the power source 60 (see FIG. 5) of the candle in an opening or indent 24 (FIG. 4) at the bottom of the power source. Two bottom LEDs (22 and 23) are depicted, but more or fewer could be used. This would allow the LEDs to be protected when the bottom of the candle is placed on a flat surface. The shape of indent 24 is not critical, nor is the use of an indent critical since the LEDs could project from the bottom of the power source or legs could project from the bottom of the power source to space the candle and power source from the surface upon which it sits.

The candle can be placed on a support 30, which is only illustrative and could be any variety of supports, such as a glass or plastic cylinder or cone shaped support, and the like. The support could be clear or transparent or colored. It will support the candle and allow an object 39 placed under the support to be illuminated by the bottom LED lights 22 or 23 (FIG. 4), or the illumination can be of the support itself. The support, as shown in FIG. 1, includes a support top 32, support legs 34 and an opening 38 which allows the light beam 36 to shine on an object below the bottom LED lights. The support 30 shown in FIG. 2 is a pedestal, which is translucent and thus emits and gives the base a warm glow, as is noted by light beam 36 with the base being give a glow via the LED light(s), and which in turn will give off light.

In another embodiment (not shown) the base could be a low-profile support, but would disburse light. It could be an annular or conic solid body that disburses and transmits light, appearing like an inverted vase or truncated cone, or a cup-like or tire-like shape having an interior ledge to support the LED candle. It could be transparent, translucent, or have a frosted appearance, or a combination of all three. For example, it could have the present LED candle in a base such that the LED gives the appearance of a glowing base. The emitted light could be a specific color or change colors over time.

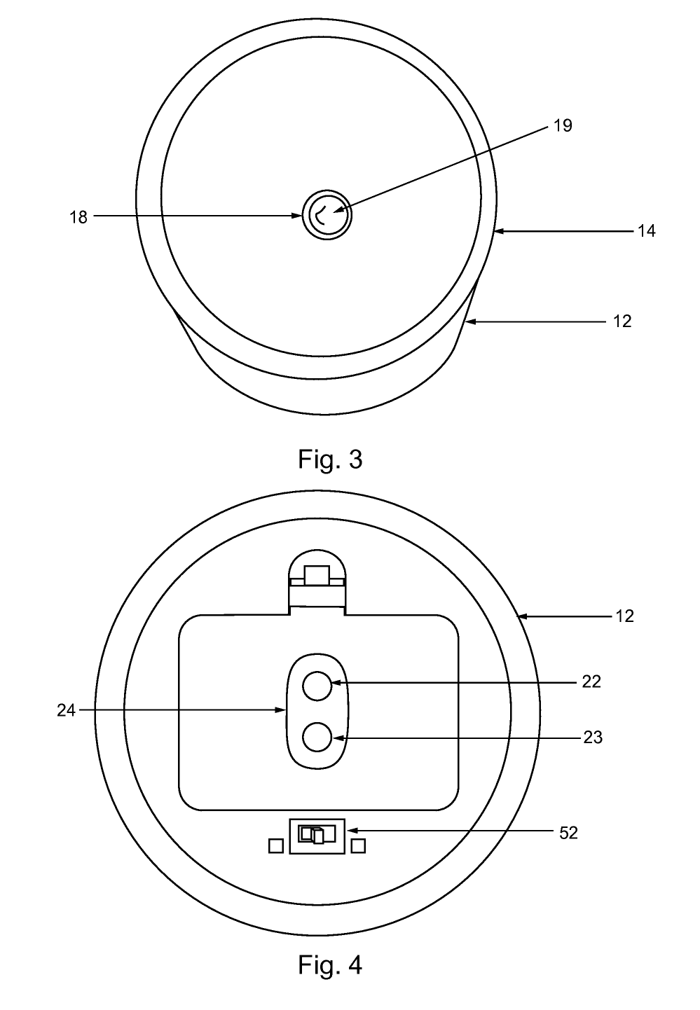

As seen in FIGS. 3 and 4, the top and bottom of shell 12, provide a recess so that the LEDs are in a depression or recess and provide the appearance of a candle as it burns and creates a wax depression. As will be explained further, the depressions at the top and bottom of the faux candle of the present invention may formed by the top and bottom of the power source which houses the batteries, the circuitry, and connections for the LED lights. An on/off switch 52 is provided in the bottom of the power source. But, in the embodiment shown the depression or recess at the top of the candle is formed as part of the candle shell so that the top of the power source will abut against the top of the candle shell and the bottom of the power source will be part of the bottom of the candle. An opening 18 in top of the candle shell will allow the flame cover 19 and LED 20 to project through the top of the candle shell and into the recess or depression at the top of the candle shell. This creates the appearance of a candle where the melting of the wax has formed a depression which surrounds the burning flame, which in this instance is an LED with a flame cover.

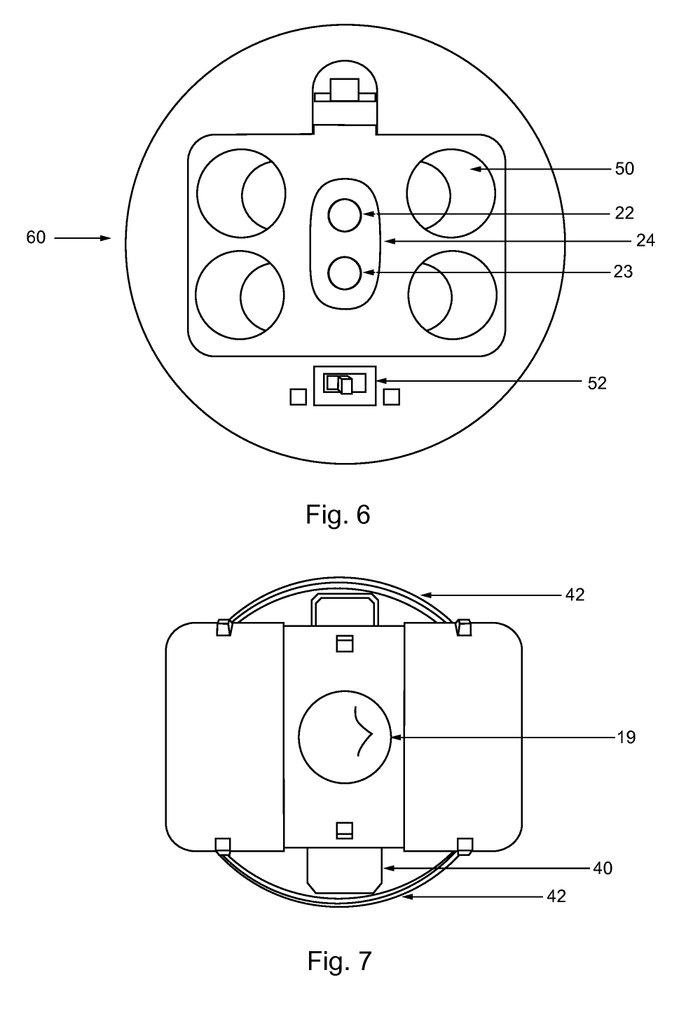

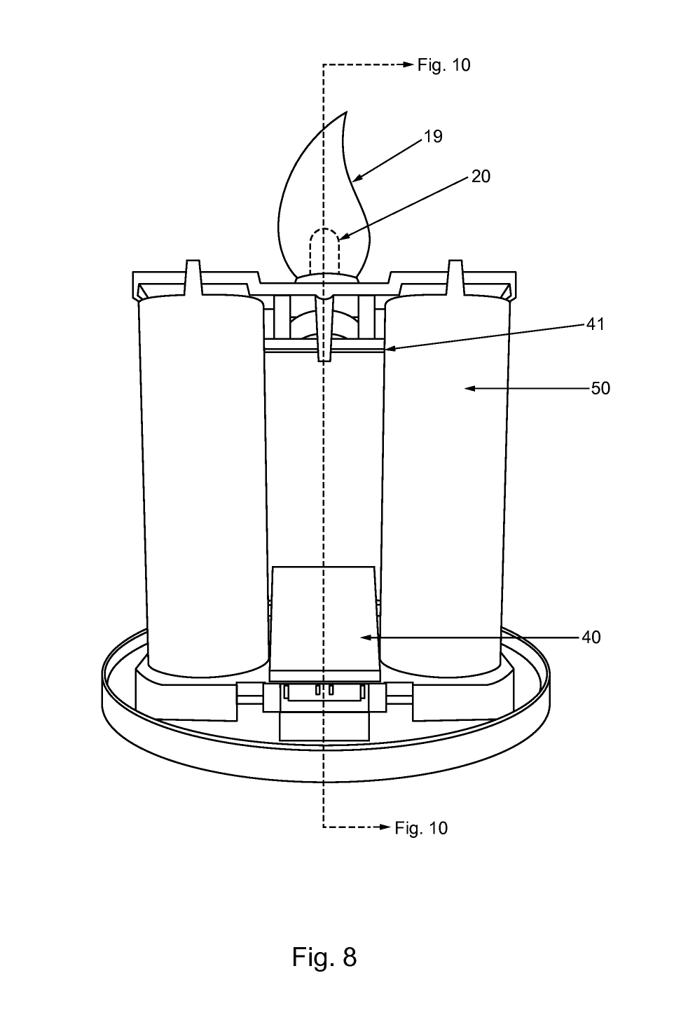

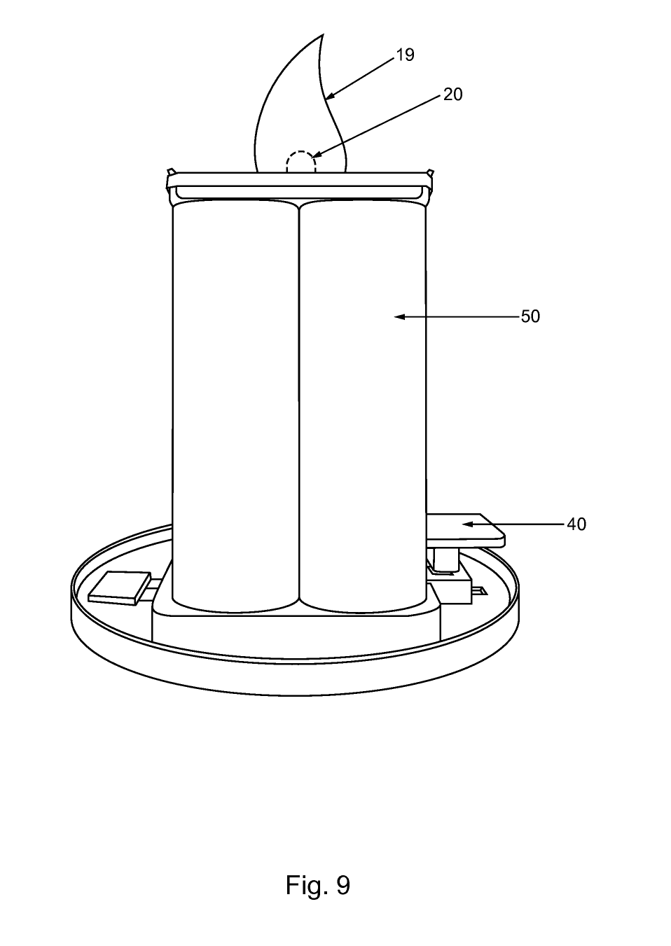

Referring to FIGS. 5, 6 and 7, the power source 60 can be unitized in that the LEDs are connected to the control circuitry and battery power source as a unit, and then the power source 60 can then be inserted into the candle housing 12. The power source can be joined to the candle housing by any conventional means, such as wax or plastic coating (or solder), force fit, screw fit, snap fit, and the like. There can be an LED control and power unit for each end of the candle or there could be one unit, as is preferred, which controls the LED lights at both ends. For the purpose of illustration, one power and control unit is shown and there is one LED for the top end and two LEDs for the bottom end. If two separate power/control units are used, they can be identical, but placed bottom to bottom to create a unit having two LED lights with one pointing out of the top and the other pointing out of the bottom. Electrical wires 42 electrically connect the LED unit to a circuit board 40, which controls the operation of the LED lights. A circuit board 40 is disposed within the power unit at the bottom of the unit to control the lower LEDs and so that it hidden from view. Another circuit board 41 is located at the top to facilitate control of the top LED. A driver circuit (not shown) (or circuit board) includes a controller and a resistor mounted on the circuit board in electrical connection with the LEDs. The LED and the controller are powered by one or more batteries (not shown) in a battery housing 50 and electrically connected to the circuit boards 40 and 41. It is understood that LED may be powered by a power source other than batteries. The driver circuit, including the controller and a resistor, is configured to modulate, by pulse-width modulation, a duty cycle from the batteries to control the amount of power supplied to the LED so that the LED flickers in an apparently random pattern. The flickering of the LED resembles a flickering flame of a candle. Other ways of modulating the duty cycle of a power source to produce a flickering light do not depart from the scope of the present invention. Moreover, having the LED not flicker would not depart from the scope of the invention. The light-emitting apparatus may be constructed in other ways to power the LED without departing from the scope of the present invention.

An on/off switch 52 at the bottom of the housing is connected to the external switch and allows a user to turn the LED on and off. The on/off switch may be arranged in other ways and the housing may include other types of battery receptacles for receiving other types of batteries without departing from the scope of the present invention.

In operation, the flameless candle can be lit at both ends, either together or one at a time (top or bottom). The light on the top of the candle simulates a real candle flame. The light at the bottom of the faux candle has enough light to illuminate object(s) below it. The size and shape of the candle can vary. The candle of the present invention can be alone or along with other products that will enhance the features of the unit, such as but not limited to: glass shades; stands made of metal, glass, ceramic, plastic etc; suspension devices made of metal, glass, ceramic, plastic etc.; figurines, trinkets etc. made of glass, metal, ceramic, plastic that are sized to fit under the suspended candle to catch the under light beam. The light switch 46 (see FIG. 10) can be operated via the candle flame 19 and will allow for both the lights to operate at the same time or either the top or the bottom at one time. Switch 46 can be a three way switch so that it will turn on one or the other LEDs or turn them both off. Such switches are known in the art, but the preferred operation is to have the flame 19 enabled so that by pushing it down, it will cycle through the various switch modes. In addition a timer maybe available, therefore the light(s) will turn on/off automatically.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What I claim is:

1. A faux candle having dual light sources comprising:
A. a housing extending longitudinally and having a top end and a bottom end, which creates the appearance of a candle, having an interior space extending longitudinally throughout the housing,
B. a first light source in the interior space of the housing located at the top end of the housing and projecting upward from the interior space to provide a candle flame simulation,
C. a second light source in the interior space of the housing located at the bottom end of the housing for projecting light downward from the end of the housing, and
D. a power source means located in the interior space for powering the light sources.

2. The candle of claim 1 wherein said light sources are light-emitting diodes (LEDs).

3. The candle of claim 1 wherein the housing is a waxed material.

4. The candle of claim 1 wherein the candle is mounted on a stand having means for facilitating the downward transmission of light.

5. The candle of claim 1 wherein said first light source has means for causing the light to flicker and simulate a flickering candle.

6. The candle of claim 1 wherein the power source includes a battery.

7. The candle of claim 1 wherein each light source has a separate power source.

8. The candle of claim 1 wherein the candle further includes a driver circuit to modulate the amount of power supplied to the light source so that the light source flickers.

9. The candle of claim 1 wherein the power source further includes a switch to power on the candle.

10. The candle of claim 1 wherein said housing has a recessed wall from said top end at said top end and said wall has an opening for passage of said first light source and said bottom end is open to allow said power source to be inserted into the interior of said housing and so that said first light source will project from said recessed wall.

11. The candle of claim 10 wherein said power source abuts against said recessed wall.

12. The candle of claim 1 wherein said first light source is a LED light having a flame shaped cover over it and said light source is connected to a switch means which controls the second light source.

13. The candle of claim 1 wherein the power source further includes a timer.

14. The candle of claim 9 wherein said switch is selected from the group consisting of touch sensor, vibration sensor, motion sensor, light sensor, remote control, and combinations thereof.
